(19) United States
(12) Patent Application Publication
(10) Pub. No.: US 2002/0168147 A1
(43) Pub. Date: Nov. 14, 2002

(54) Optical circuit pick and place machine

(76) Inventors: Steven K. Case, St. Louis Park, MN (US); Gregory S. Mowry, Burnsville, MN (US); Timothy A. Skunes, Mahtomedi, MN (US); John T. McElreath, Mahtomedi, MN (US); Patrick J. Garfield, Mahtomedi, MN (US); Craig D. Knighton, Coon Rapids, MN (US)

Correspondence Address: WESTMAN, CHAMPLIN & KELLY, A PROFESSIONAL ASSOCIATION, SUITE 1600 - INTERNATIONAL CENTRE, 900 SECOND AVENUE SOUTH, MINNEAPOLIS, MN, 55402-3319, US

(21) Appl. No.: 10/098,743

(22) Filed: Mar. 15, 2002

Related U.S. Application Data
(63) Continuation-in-part of application No. 09/789,125, filed on Feb. 20, 2001.
(63) Continuation-in-part of application No. 09/789,185, filed on Feb. 20, 2001, now Pat. No. 6,443,631.
(63) Continuation-in-part of application No. 09/789,124, filed on Feb. 20, 2001.
(63) Continuation-in-part of application No. 09/789,317, filed on Feb. 20, 2001.
(63) Continuation-in-part of application No. PCT/US02/05497, filed on Feb. 20, 2002.
(63) Continuation-in-part of application No. PCT/US02/05412, filed on Feb. 20, 2002.
(63) Continuation-in-part of application No. PCT/US02/05268, filed on Feb. 20, 2002.
(63) Continuation-in-part of application No. PCT/US02/05498, filed on Feb. 20, 2002.
(60) Provisional application No. 60/276,323, filed on Mar. 16, 2001.
(60) Provisional application No. 60/288,169, filed on May 2, 2001.
(60) Provisional application No. 60/318,399, filed on Sep. 10, 2001.

(51) Int. Cl. G02B 6/36; G02B 6/26

(52) U.S. Cl. 385/53; 385/52; 385/147

(57) ABSTRACT

A method and apparatus for automatically assembling an optical device is provided. Prealigned optical modules are mounted by a pick and place machine onto a fixed reference.

The present application is based on and claims the benefit of U.S. provisional patent application Ser. No. 60/276,323, filed Mar. 16, 2001, Ser. No. 60/288,169, filed May 2, 2001, Ser. No. 60/318,399, filed Sep. 10, 2001, the present application is also a Continuation-In-Part of U.S. patent application Ser. No. 09/789,1256, filed Feb. 20, 2001, Ser. No. 09/789,185, filed Feb. 20, 2001, Ser. No. 09/789,124, filed Feb. 20, 2001, and Ser. No. 09/789,317, filed Feb. 20, 2001 and is also a Continuation-In-Part of PCT Ser. No. PCT/US02/______ (A48.13-002), filed Feb. 20, 2002, PCT Ser. No. PCT/US02/______ (A48.13-0003), filed Feb. 20, 2002, PCT Ser. No. PCT/US02/______ (A48.13-0004), filed Feb. 20, 2002, and PCT Ser. No. PCT/US02/_____ (A48.13-0005), filed Feb. 20, 2002, the contents of which are hereby incorporated by reference in their entirety.

Cross-reference is made to co-pending applications Ser. No. 09/789,125, filed Feb. 20, 2001, entitled OPTICAL MODULE; Ser. No. 09/789,185, filed Feb. 20, 2001, entitled OPTICAL MODULE WITH SOLDER BOND; Ser. No. 09/789,124, filed Feb. 20, 2001, entitled OPTICAL DEVICE; Ser. No. 09/789,317, filed Feb. 20, 2001, entitled OPTICAL ALIGNMENT SYSTEM; Ser. No. 60/276,323, filed Mar. 16, 2001, entitled OPTICAL CIRCUIT PICK AND PLACE MACHINE; Ser. No. 60/276,335, filed Mar. 16, 2001, entitled OPTICAL CIRCUITS WITH ELECTRICAL SIGNAL ROUTING; Ser. No. 60/276,336, filed Mar. 16, 2001, entitled OPTICAL CIRCUITS WITH THERMAL MANAGEMENT; Ser. No. 09/894,872, filed Jun. 27, 2001, entitled AUTOMATED OPTO-ELECTRONIC ASSEMBLY MACHINE AND METHOD; Ser. No. 09/920,366, filed Aug. 1, 2001, entitled OPTICAL DEVICE; Ser. No. 60/318,399, filed Sep. 10, 2001, entitled OPTICAL CIRCUIT PICK AND PLACE MACHINE; Ser. No. 60/288,169, filed May 2, 2001, entitled OPTICAL CIRCUIT PICK AND PLACE MACHINE, and Ser. No. 60/340,114, filed Dec. 14, 2001, entitled OPTICAL MODULE AND DEVICE, PCT Serial No. PCT/US02/______ (A48.13-0002), filed Feb. 20, 2002, PCT Serial No. PCT/US02/______ (A48.13-0003), filed Feb. 20, 2002, PCT Serial No. PCT/US02/______ (A48.13-0004), filed Feb. 20, 2002, and PCT Serial No. PCT/US02/______ (A48.13-0005), filed Feb. 20, 2002, which are incorporated by reference herein in their entirety.

### BACKGROUND OF THE INVENTION

The present invention relates to optical devices. More specifically, the present invention relates to the assembly of optical devices.

Optical devices are being increasingly used in various industries and technologies in order to provide high speed data transfer, such as through fiber optic communication equipment. In many applications there is a transition or an incorporation of optical devices where previously only electrical devices were employed. An optical device typically consists of a number of components that must be precisely assembled and aligned for the device to operate and function efficiently. Example components include fibers, waveguides, lasers, modulators, detectors, gratings, optical amplifiers, lenses, mirrors, prisms, windows, etc.

Historically, optical devices such as those used in fiber optic telecommunications, data storage and retrieval, optical inspection, etc. have had little commonality in packaging and assembly methods. This limits the applicability of automation equipment for automating the manufacture of these devices since there is such a disparity in the device designs. To affect high volume automated manufacturing of such devices, parts of each individual manufacturing line have to be custom-designed.

In contrast, industries such as printed circuit board manufacturing and semiconductor manufacturing have both evolved to have common design rules and packaging methods. This allows the same piece of automation equipment to be applied to a multitude of designs. Using printed circuits as an example, diverse applications ranging from computer motherboards to cellular telephones may be designed from relatively the same set of fundamental building blocks. These building blocks include printed circuit boards, integrated circuit chips, discrete capacitors, and so forth. Furthermore, the same automation equipment, such as a pick and place machine, is adaptable to the assembly of each of these designs because they use common components and design rules. U.S. Pat. No. 5,894,657, issued Apr. 20, 1999, entitled MOUNTING APPARATUS FOR ELECTRONIC COMPONENT and U.S. Pat. No. 6,148,511, issued Nov. 21, 2000, entitled ELECTRONIC COMPONENT MOUNTING MACHINE AND METHOD THEREFOR are examples of such automation equipment.

Further complications arise in automated assembly of optical devices. Such assembly is complicated because of the precise mechanical alignment requirements of optical components. This adds to problems that arise due to design variations. The problem arises from the fact that many characteristics of optical components cannot be economically controlled to exacting tolerances. Examples of these properties include the fiber core concentricity with respect to the cladding, the location of the optical axis of a lens with respect to its outside mechanical dimensions, the back focal position of a lens, the spectral characteristics of a thin-film interference filter, etc. Even if the mechanical mounting of each optical element were such that each element was located in its exact theoretical design position, due to the tolerances listed above, the performance specifications of the optical device may not be met.

To appreciate the exacting alignment requirements of high performance optical devices, consider the simple example of aligning two single mode optical fibers. In this example, the following mechanical alignments are required to ensure adequate light coupling from one fiber to the other: the angle of the fibers with respect to each other, the fiber face angle, the transverse alignment (perpendicular to the light propagation direction) and the longitudinal spacing (parallel to the light propagation direction).

Typical single mode optical fibers used in fiber optic communications for the 1.3 μm to 1.6 μm wavelength band have an effective core diameter of about 9 microns and an outside cladding dimension of 125 microns. The typical tolerance for the concentricity of the core to the outside diameter of the cladding is 1 micron. If the outside claddings of the two fibers were perfectly aligned and there is no angular misalignment or longitudinal spacing, the cores may still be transversely misaligned by as much as 2 microns. This misalignment would give a theoretical coupling loss of about 14 percent or 0.65 dB. This loss is unacceptable in many applications. Further, optical devices are frequently manually assembled. Manual assembly is a slow and expensive process which has relatively low yields.

### SUMMARY OF THE INVENTION

A method and apparatus for automatically assembling an optical device is provided. Prealigned optical modules are mounted by a pick and place machine onto a fixed reference.

### BRIEF DESCRIPTION OF THE DRAWINGS

FIG. 1 is a diagram of a pick and place machine for placing prealigned optical modules to form an optical device.

FIG. 2 is a block diagram showing various example components of a pick and place machine.

FIG. 3 is a perspective view of one specific embodiment of a pick and place machine in accordance with the present invention.

FIG. 4 is a perspective view of a optical device formed from two prealigned optical modules placed together using a pick and place machine of the invention.

FIG. 5 is a front plan view of an optical module of FIG. 4.

FIG. 6 is a top plan view of a fixed reference of the optical device of FIG. 4.

FIG. 7 is a front plan view of another example optical module.

FIG. 8 is a plan view of an example pick and place machine head.

FIG. 9 is a front cross-sectional view showing a registration feature that registers an optical module in a fixed reference.

FIGS. 10A, 10B and 10C are cross-sectional views showing the operation of registration features.

FIG. 11 is a cutaway plan view of a quill for use in a pick and place machine of the invention.

FIG. 12 is a plan view of a laser transmitter optical device.

FIG. 13 is a top plan view showing two fiber cassettes in a carrier.

FIG. 14 is a cutaway perspective view of a cradle shown in FIG. 13.

FIG. 15 is a cutaway top plan view and FIG. 16 is a cutaway exploded perspective view showing optical modules carried in cradles adjacent a fixed reference.

FIG. 17 is a perspective view of a cassette held by a vacuum gripper assembly.

FIG. 18 is a block diagram showing example steps during operation of the pick and place machine of FIG. 3.

FIG. 19 is a simplified block diagram of a cradle and tray assembly.

FIG. 20 is a perspective view of an alternative fiber component holder.

FIG. 21 is a cross-sectional view showing electrical trace features used to verify proper registration of an optical module and a fixed reference.

### DETAILED DESCRIPTION OF THE PREFERRED EMBODIMENTS

With the invention, a prealigned optical module is initially positioned with relatively low accuracy on a fixed reference substrate. Subsequently, registration features are used to passively position the module with relatively high accuracy. (The optical module is prealigned with respect to the registration features.) This technique lends itself to large scale, automated assembly of optical devices, including opto-electronic devices, such as fiber optic communication devices.

Examples of prealigned opto-electronic devices include devices that carry components such as a fiber, lens, laser, filter, grating, prism, etc. The prealignment is with sub-micron accuracy and removes component variations. The optical modules are then mounted onto a fixed reference substrate (also referred to herein as an optical circuit board) with the present invention. Both the optical modules and optical circuit boards have mating registration features that cooperate to easily facilitate sub-micron mechanical and optical alignment.

A wide variety of optical circuits (or devices) such as laser transmitters, add/drop multiplexers, optical amplifiers, and optical switches may be assembled by mounting the appropriate optical modules onto an appropriately configured optical circuit board. One great advantage of building optical circuits in this fashion is that the automated optical circuit pick and place equipment for populating the optical circuit board does not need sub-micron positional accuracy. As the modules are urged into the circuit board, the mating registration features between the optical modules and the optical circuit board passively guide the placement of the modules onto the circuit board to obtain the sub-micron mechanical and optical alignment. The positional accuracy of pick and place machine need only be sufficient to deliver the optical module close enough to the optical circuit board to initiate the guiding process provided by the registration features. Any appropriate method to perform the final guiding can be used and the invention is not limited to those specifically set forth herein in order to achieve the final sub-micron accuracy placement of the opto-electronic element. The optical modules are then secured to the optical circuit board.

Because the optical circuit pick and place machine is not required to have sub-micron positional accuracy its cost and complexity can be greatly reduced. Also sub-micron accuracy positioning systems are characterized, in general, as having low speed and short travel lengths. Therefore, the present invention allows much faster assembly times than prior art methods of assembling optical devices and at the same time removes the negative effects of component variations.

Other opto-electronic and electronic components may also be assembled by the present invention directly onto the optical circuit board with or without registration features. These components may have less precise registration features if the mechanical and optical alignment requirements are not critical. Example components include, but are not limited to, integrated circuits, electrical resistors, and optical detectors.

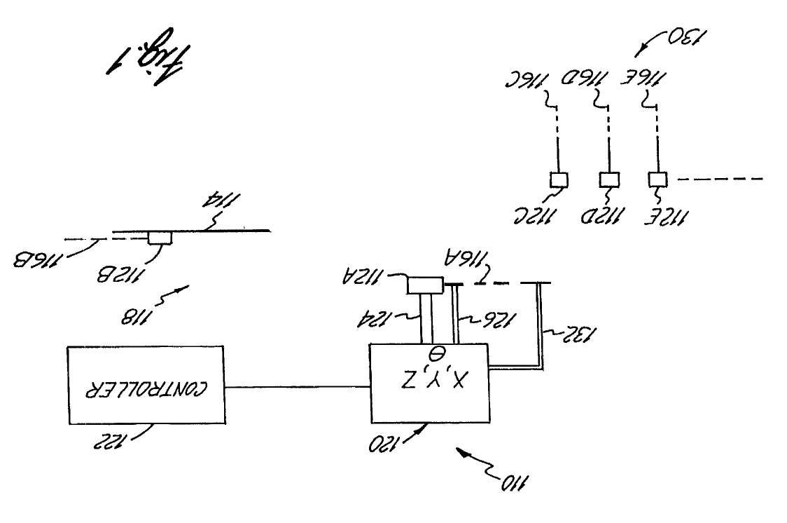

FIG. 1 is a simplified diagram showing a pick and place machine 110 in accordance with the present invention. Pick and place machine 110 is configured to place a prealigned optical module 112A, which includes an optical component, onto a fixed reference 114 which could be, for example, a substrate or other configuration. The optical module 112A can include a fiber optic “pigtail” 116A and, in such embodiments, the pick and place machine 110 is configured to grasp the pigtail 116A. In FIG. 1, a second optical module 112B having a pigtail 116B is shown as mounted on fixed reference 114. Because the optical modules 112A and 112B are prealigned, when they are placed at predetermined locations on fixed reference 114 they will be in optical alignment with one another such that they can cooperate and form an optical device 118.

Pick and place machine 110 includes an actuator 120 that is controlled by a controller 122. The actuator 120 moves a gripper linearly and/or rotationally about one or more axes. Various types of sensors can be used to provide feedback to controller 122 to control actuator 120. The gripper 124 grips the optical modules. An optional fiber gripper 126 can be provided to grip the pigtails from optical modules. Pick and place machine 110 is also configured to receive a source 130 of optical modules and other components 112C, 112D, 112E . . . which each may have fiber pigtails 116C, 116D, 116E . . . Source 130 can be some type of a tray or other component delivery mechanism that can be loaded into machine 110 such that gripper 124 can grip the optical modules.

In one aspect, the present invention includes obtaining a plurality of prealigned modules and a fixed reference. The modules and the substrate both have registration features configured to mate with one another. Registration features of at least one of the modules is initially aligned with a registration feature of the substrate. This initial aligning is performed with a first level of accuracy. The module and the substrate are urged together such that the registration features cooperate with one another and passively align the optical module and the substrate due to this cooperation. This passive alignment is at a second level of accuracy that is greater than the first level of accuracy.

In one optional aspect, a distal end gripper 132 is provided for gripping a distal end of the fiber pigtail 116 from an optical module 112. The invention broadly includes a pick and place machine configured to carry a prealigned optical module (which may include electrical components) and support a fiber optic pigtail which extends from the module. These pigtails can be quite long, for example several meters, and holding and controlling them during the placing process significantly increases the ability of a pick and place machine to be used in automated assembly of optical devices. More specific examples of various components or configurations of a pick and place machine are set forth herein, however, the invention is not limited to any of these specific examples or aspects.

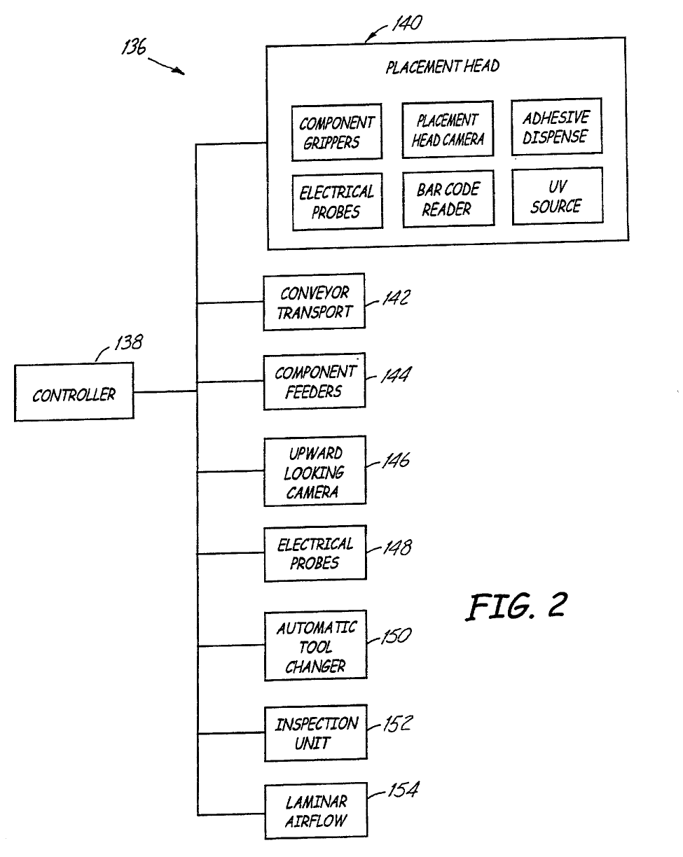

FIG. 2 is a block diagram of a pick and place machine 136 that shows additional optional components of the machine. A controller 138 couples to a moving placement head 140, a transport conveyor 142, component feeders 144, upward looking camera 146, electrical probe 148, automatic tool changer 150, inspection until 152 and laminar air flow source 154. In operation, controller 138 operates component feeders such that placement head 140 can grip a component such as an optical module. The optical module can be oriented using upward looking camera 146 and/or a placement head camera carried on head 140. Controller 138 can select from multiple tools in automatic tool changer 150 for use on placement head 140. A laminar air flow 154 is provided for clean room conditions. The controller can also activate electrical probes 148 for use in soldering an optical module and/or providing electrical connections. The probes 148 may, in some embodiments, be carried on placement head 140 or extend from a work surface on which an optical module is placed. Placement head 140 includes one or more component grippers for gripping an optical module, an adhesive dispenser and a curing source, such as an ultraviolet source. A bar code reader can be carried on placement head 140 to read encoded bar code information. The bar code can be used for tracking optical modules.

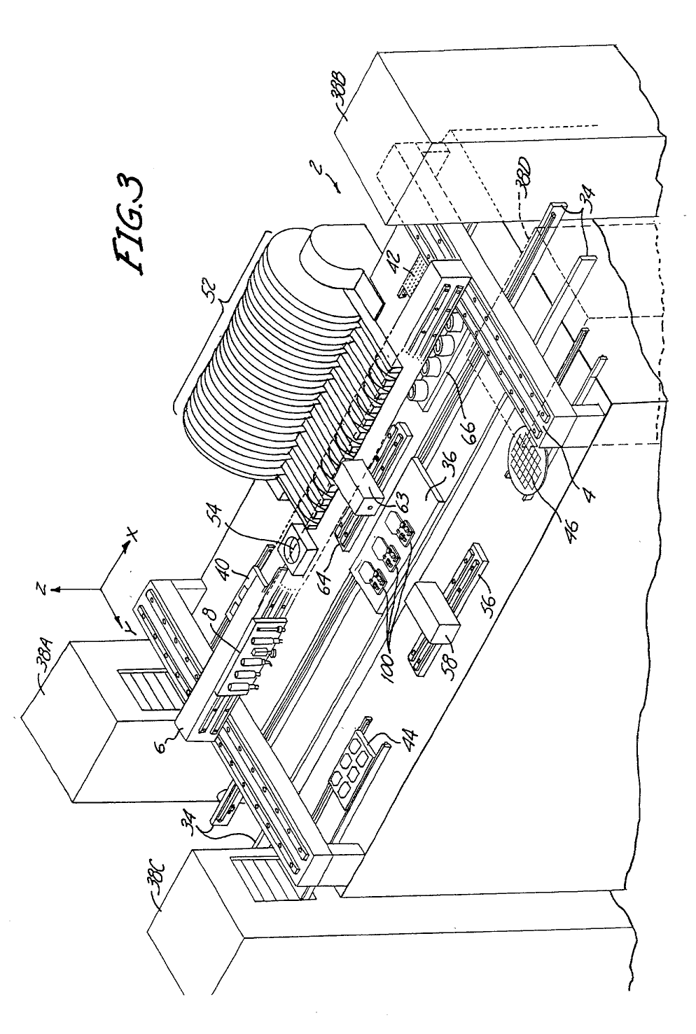

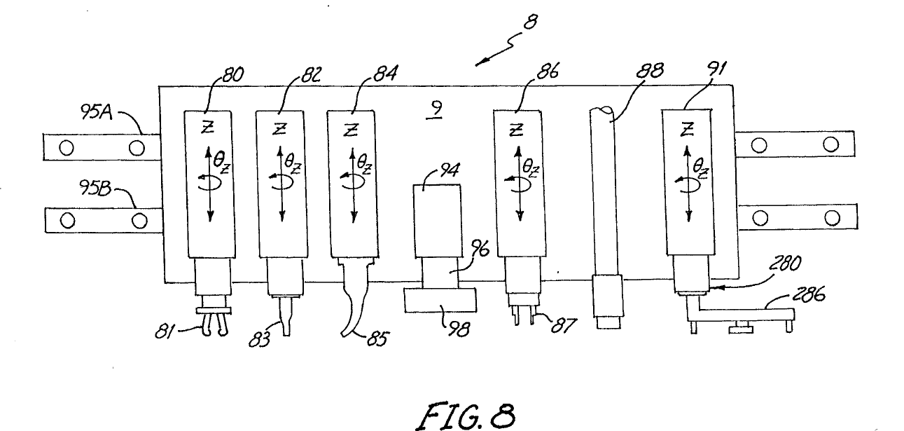

FIG. 3 shows a more specific example of a pick and place machine 2 adapted to assemble optical circuits consisting of parts such as optical elements, pre-aligned optical modules, optical circuit boards, opto-electronic components, and electrical components. These parts are presented to placement head 8 by reel feeders 52 as well as part trays 40, 42, 44, and 46. Tray stackers 38A, 38B, 38C, and 38D contain multiple part trays 40, 42, 44, and 46, respectively. Placement head 8, shown in more detail in FIG. 8, is attached to gantry 6 and is capable of movement in the X direction. Gantry 6 is capable of being driven in the Y direction by linear motors 4.

Assembly tray 36 is delivered into pick and place machine 2 on conveyor rails 34. Assembly tray 36 is used as a temporary carrier for assembling multiple optical circuits 100. Assembly tray 36, once populated with assembled optical circuits 100, would be used in a subsequent final packaging and sealing operation. Optical circuit 100 is shown in more detail in FIG. 11.

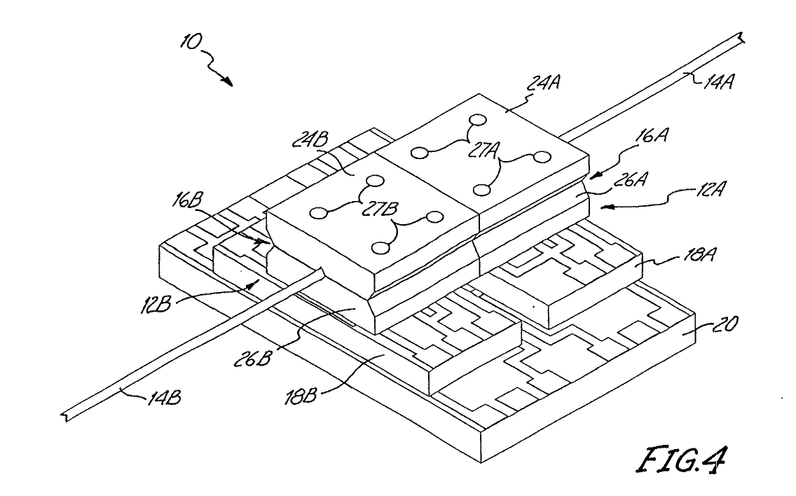

Referring now to FIG. 4, a perspective view of another example optical circuit (or device) 10 is shown. Optical circuit 10 is shown as a simple optical fiber to optical fiber coupler. However, the invention is applicable to more complex or other optical circuits containing other types of optical, opto-electronic, and electronic components. Other example optical components include, but are not limited to, lenses, filters, waveguides, diffraction gratings, polarizers, and prisms. Example opto-electronic components include, but are not limited to, lasers, detectors, modulators, optical switches, and semiconductor optical amplifiers. Example electronic components include, but are not limited to, integrated circuit die, packaged integrated circuits such as flip-chips and ball grid arrays, resistors, inductors, and capacitors.

Optical circuit 10 is fabricated from two fiber modules 12A and 12B which include respective optical components 14A and 14B illustrated in this specific example as optical fibers. The fibers are mounted to respective optical component mounts 16A and 16B which are positioned and oriented to achieve a desired position and orientation of optical components 14A and 14B relative to base mounting plates 18A and 18B, respectively. A refractive index optical matching material may be used to fill any gap between adjacent interface faces of optical components 14A and 14B to provide improved coupling and reduce reflections. For example, the optical matching material may be an optical adhesive that is curable by heat, radiation, or both. In the example illustrations specifically set forth in FIG. 4, base mounting plates 18A and 18B comprise substantially planar mating plates. Base mounting plates 18A, 18B are one example of a relative reference mount. Base mounting plates 18A and 18B mount to optical circuit board (substrate or fixed reference) 20 such that the optical components 14A and 14B are in substantial alignment. Substrate 20 is one example of a fixed reference mount. Also shown in FIG. 4 are alignment registration marks 27A and 27B used by placement head camera 94, shown in FIG. 8, in order that pick and place head 8 may accurately pick up parts such as fiber modules 12A and 12B from the part trays and tape and reel feeders.

The optical modules are pre-assembled and pre-aligned to an appropriate reference with respect to the registration features on the module such that during assembly of optical circuit 10 by pick and place machine 2, a final optical circuit is fabricated by simply mounting prealigned optical modules on the reference substrate. Optical modules can include, but are not limited to, fiber modules, lens modules, laser modules, filter modules, waveguide modules, detector modules, etc. In the example of FIG. 4, fixed reference 20 is illustrated as a planar substrate which can be thought of (and is referred to herein in some instances) as an optical circuit board which receives parts such as optical modules, optical components, opto-electronic components, and electronic components to form an optical circuit.

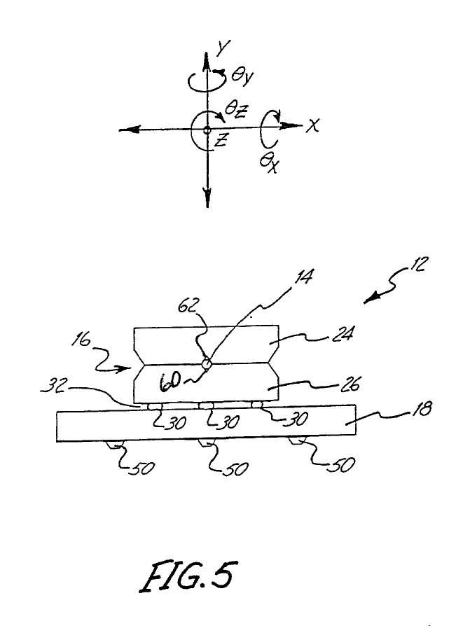

FIG. 5 is a front plan view of fiber module 12 showing optical component mount 16 adjacent base mounting plate 18. Prior to fixedly adhering mount 16 to mount 18 with bonding material 30 either component mount 16 and base mounting plate 18 may be manipulated through up to six degrees of freedom as illustrated by the axes labeled X, Y, θₓ, θ_{y}, and θ_{z} in FIG. 5 along with another Z axis which is not shown and is perpendicular to a plane of the Figure. This manipulation can be achieved because there is a gap 32 between mount 16 and plate 18. For some optical components, all six degrees of freedom may not be required for proper alignment and fewer degrees of freedom can be provided. FIG. 5 also illustrates example registration features 50. In the example embodiment of FIG. 5, each registration feature 50 is a protrusion that is configured to mate with fixed reference 20 as discussed below.

FIG. 5 also shows a component registration feature 60 formed in lower component mount 26 and a component registration feature 62 in upper component mount 24. In general, any registration technique can be used and is not limited to the specific example illustrated herein. In the example embodiment, component registration features 60 and 62 comprise V-grooves that are configured to receive an optical component such as optical component 14. The optical component 14 can be coupled to the optical component mount using, for example, an adhesive or solder. Optical component 14 is preferably fixed to component mount 16 to maintain alignment relative to registration features 50 of relative reference mount 18.

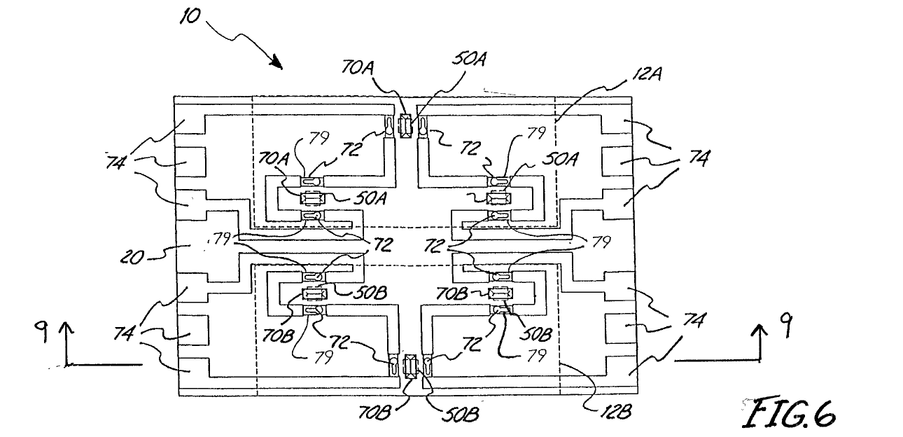

FIG. 6 is a top plan view of fixed reference 20 configured to receive optical modules 12A and 12B shown in FIG. 4. Registration features 70A and 70B are provided to receive registration features 50 on respective optical modules 12A and 12B. In the example embodiment, features 70 are precisely defined V-grooves configured to register the mesa registration features 50 shown in FIG. 5. The dashed outlines indicate the placement of fiber modules 12A and 12B. This configuration provides an example of a kinematic-type registration or alignment technique. One example kinematic technique is described in U.S. Pat. No. 5,748,827, entitled “TWO-STAGE KINEMATIC MOUNT”. Any appropriate registration or alignment technique can be used, however, preferably the registration technique should be accurate and provide high repeatability. In one example, the technique passively aligns the module (which contains a prealigned mount component) to the circuit board. Because an active alignment has been previously performed on the optical component, the pick and place machine can use passive alignment to place the module which simplifies the assembly process and allows for increased assembly speed. In the example embodiment, a heat activated material 72 such as solder is provided which can be heated to rapidly and fixedly adhere the modules to the reference substrate. In such an embodiment, contact pads 74 electrically couple to heaters 79 that are used to heat solder 72. Although not shown in the Figures, material 72 is preferably aligned with pads on the bottom of base mounting plates 18. These pads comprise a metal to which solder will strongly adhere. The solder can also provide electrical connections.

The bonding pads on the bottom of base mounting plate 18 may also include integral heating elements and electrical contact pads may be provided to energize these heating elements. A reduction in the bonding time may be obtained by heating both bonding pads and bonding material 72. When bonding material 72 comprises solder, pads on the bottom of base mounting plate 18 may also be pre-tinned with a thin layer of solder.

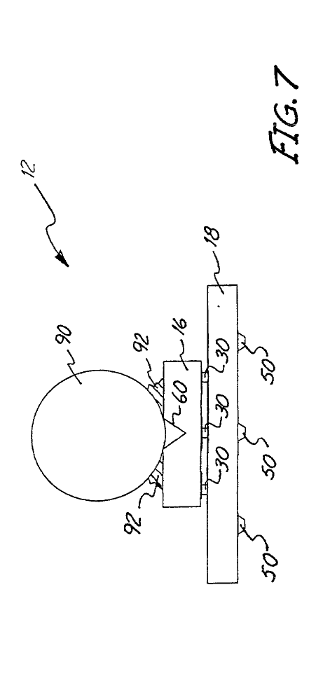

Component 14 can be any type of optical, opto-electrical or opto-mechanical element including active or passive elements. In the above examples, optical element 14 is shown as an optical fiber. To illustrate another example optical module 12, in FIG. 7 an optical element 90 is shown which comprises a GRIN lens. FIG. 7 is a front plan view showing lens 90 held in component mount 16 which coupled to base mounting plate 18. Lens 90 is registered with a registration groove 60. Additional support bonding material 92 is provided to secure lens 90 to component mount 16. This can be an adhesive, solder or other bonding material. Lens module 12 may be prealigned so that parameters such as the back focal position and optical axis of lens 90 are located precisely with respect to registration features 50. Note that the optical modules set forth herein are provided as examples and the invention is not limited to any specific type of module or configuration.

FIG. 8 shows a front elevational view of an example placement head 8 from FIG. 3. Placement head 8 includes mounting plate 9 that can translate along rails 95A and 95B. Mechanical gripper 81, used to pick and place parts, may be actuated in the Z and θ_{z} directions by articulator 80. Vacuum nozzle 83, also used to pick and place parts, may be actuated in the Z and θ_{z} directions by articulator 82. Adhesive dispensing nozzle 85 may be actuated in the Z and θ_{z} directions by articulator and pump 84. Adhesive dispensing nozzle 85 may be used for a variety of operations. These operations include, but are not limited to, securing optical modules to the optical circuit board, dispensing optical index matching adhesive between optical modules to increase light coupling and reduce reflections, dispensing conductive epoxy or solder paste to secure parts and route electrical signals, encapsulating all or portions of an optical circuit, dispensing flux, or bonding electrical components such as packaged integrated circuits, integrated circuit die, resistors, and capacitors to the optical circuit board or optical module. Additional adhesive dispensers 85 and articulator/pumps 84 may be included on placement head 8 as required.

Electrical contact probe 87, which may be actuated in the Z and θ_{z} directions by articulator 86, is used to supply electrical current to electrical heater contact pads on the optical circuit board, the optical module, or both in order to rapidly secure optical modules to the optical circuit board. Contact probe 87 may also be used to supply electrical signals to the optical circuit board to perform functional tests and may also be used to verify proper seating of optical modules onto fixed references. FIG. 8 also shows placement head camera 94, lens 96, and illumination system 98. As stated above, images from placement head camera 94 are used to accurately calculate the position of critical features on parts such as optical components, prealigned optical modules, optical circuit boards, opto-electronic components, electrical components, assembly trays, and fiber cassettes. This positional information is used to accurately pick up components from tape and reel feeders 52 as well as trays 40, 42, 44, and 46. This positional information is also used to accurately find adhesive dispensing locations as well as locating electrical heater contact pads. Furthermore, images from placement head camera 94 can be used to accurately locate registration features on an optical circuit board so that proper mating with the registration features of optical modules is obtained. Placement head camera 94 may be of the area array or linescan array type, or other imaging technique that provides positional feedback.

Illumination system 98 may provide many types of illumination such as specular, diffuse, or darkfield. The illuminator may also be divided into independent sections such that the angle of illumination may be controlled in both the azimuthal and altitudinal directions. Various wavelengths and/or polarization control of light may also be employed by illuminator 98 in order to obtain proper feature contrast. Illumination system 98 may also be strobed in order quickly acquire images or to “freeze” the effects of any motion.

Also shown in FIG. 8 is delivery fiber 88 to deliver radiation, such as UV light, which is used to cure light sensitive adhesives. The radiation source is not shown and delivery fiber 88 can emit in any range of wavelength depending on the adhesive curing requirements.

An additional radiation source, such as a laser or other infrared source, may also be supplied to heat bonding pads of the optical circuit board and optical module. To secure optical modules to the optical circuit board, a laser source could also be supplied to melt solder.

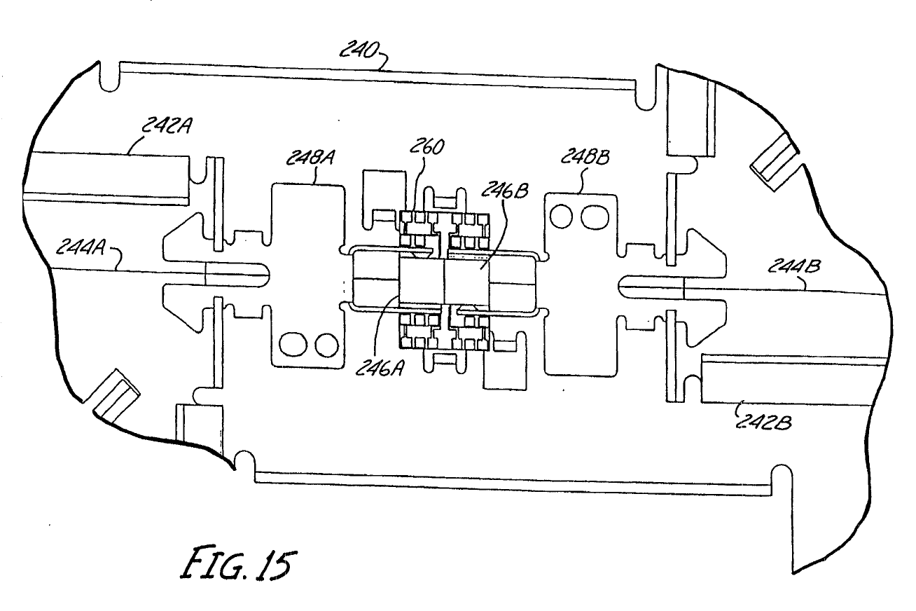

A vacuum gripper assembly 280 is also shown in FIG. 8 coupled to articulator 91. Assembly 280 is used to grip cassettes as explained below in connection with FIGS. 13-17.

It should be appreciated that the present invention is not limited to the types or numbers of grippers, dispensers, cameras, contact probes, or illumination delivery systems present on placement head 8 in FIG. 8. For example, placement head 8 may be configured with a plurality of vacuum nozzles 83 and corresponding articulators 82 with no gripper 81 and corresponding articulator 80. Alternatively, placement head 8 may advantageously employ a bar code reader in order to read bar codes from optical modules, optical circuit boards, and other components. The bar code data could be captured into a database in order to track statistical process data such as yield information versus component lot numbers. Another variation includes the use of multiple cameras on placement head 8 with different fields of view and resolutions. High resolution cameras can accurately locate small, critical features, whereas large field of view cameras can measure larger features.

Operation of pick and place machine 2 shown in FIG. 3 will now be described in more detail. Referring back to FIG. 3, images from camera and illumination system 54 are used to accurately locate critical features such as registration features 50 of optical module 12 on parts such as optical components, prealigned optical modules, optical circuit boards, opto-electronic components, and electrical components after they have been picked up by gripper 81 or vacuum nozzle 83 and prior to placement on the optical circuit board. Camera and illumination system 54 may provide many types of illumination such as specular, diffuse, or darkfield. The illuminator may also be divided into independent sections such that the angle of illumination may be controlled in both the azimuthal and altitudinal directions. Various wavelengths and/or polarization of light may also be employed by camera and illumination system 54 in order to obtain proper feature contrast. Camera and illumination system 54 may also be strobed in order quickly acquire images or to “freeze” the effects of any motion. The electronic imager in camera and illumination system 54 may be of the area array or linear array types.

Also shown in FIG. 3 is automatic tool changer 66 that is adapted to automatically supply a plurality of grippers, vacuum nozzles, or electrical contact probes to placement head 8. These additional grippers, nozzles, and electrical contact probes may be required depending on the physical geometry of the parts or optical circuit board.

FIG. 3 also shows inspection units 58 and 63. These may be used to perform final functional tests such as insertion loss, return loss, and wavelength accuracy. Inspection units 58 and 63 are aligned to optical circuits on assembly tray 36 using linear motors 56 and 64, respectively.

Not shown in FIG. 3 is optional laminar air flow source. This laminar air flow source provides a constant flow of clean air flowing in the assembly area of pick and place machine 2 so that contaminants do not settle into the registration features of either the optical circuit boards or optical modules. The clean laminar air flow also prevents sensitive optical surfaces from becoming contaminated.

In general, pick and place machine 2 assembles optical circuits in the following manner. Placement head 8 is positioned over an optical circuit board. Either a part tray or a reel feeder may present the optical circuit board. An image of the optical circuit board is then captured by placement head camera 94 so that the proper pick up location of the optical circuit board may be calculated by a controller. Placement head 8 then picks up the optical circuit board and presents it to camera and illumination system 54. The image from system 54 is used to calculate the location of critical features such as registration features. Placement head 8 is then positioned over assembly tray 36. An image of assembly tray 36 is captured by placement head camera 94 so that the proper placement location of the optical circuit board onto assembly tray 36 may be calculated by a controller. The optical circuit board is then placed onto assembly tray 36.

Placement head 8 is then positioned over an optical module, optical component, opto-electronic component, or an electronic component. A part tray, reel feeder, or other feeder mechanism may present these components. An image of the component is then captured by placement head camera 94 so that the proper pick up location of component may be calculated by a controller. Placement head 8 then picks up the component and presents it to camera and illumination system 54. The image from camera and illumination system 54 is used to calculate locations of critical component features such as optical module registration features. Placement head 8 is then positioned over the optical circuit board. An image of the optical circuit board is captured by placement head camera 94 so that the proper placement location of the component onto the optical circuit may be calculated by a controller. The component is then placed on the optical circuit board.

If necessary, contact probes 87 are engaged with optical module contact pads in order to heat the solder and rapidly secure the optical module to the optical circuit board. Optionally, a local atmosphere of gas, such as nitrogen or forming gas (nitrogen with a small percentage of hydrogen), may be supplied around the optical circuit board during the securing process. This removes oxygen and prevents or removes oxidation of the solder to improve the quality of the solder bond. Alternatively, adhesive may be dispensed onto the optical circuit board in order to attach the optical module. Other securing methods are also possible.

The process of placing components onto the optical circuit board continues until the optical circuit board is fully populated and all components are secured. Additional adhesive such as a refractive index matching material can be dispensed as appropriate. All or portions of the optical circuit can be encapsulated by epoxy. Radiation from fiber delivery system 88 can be used to cure the adhesives.

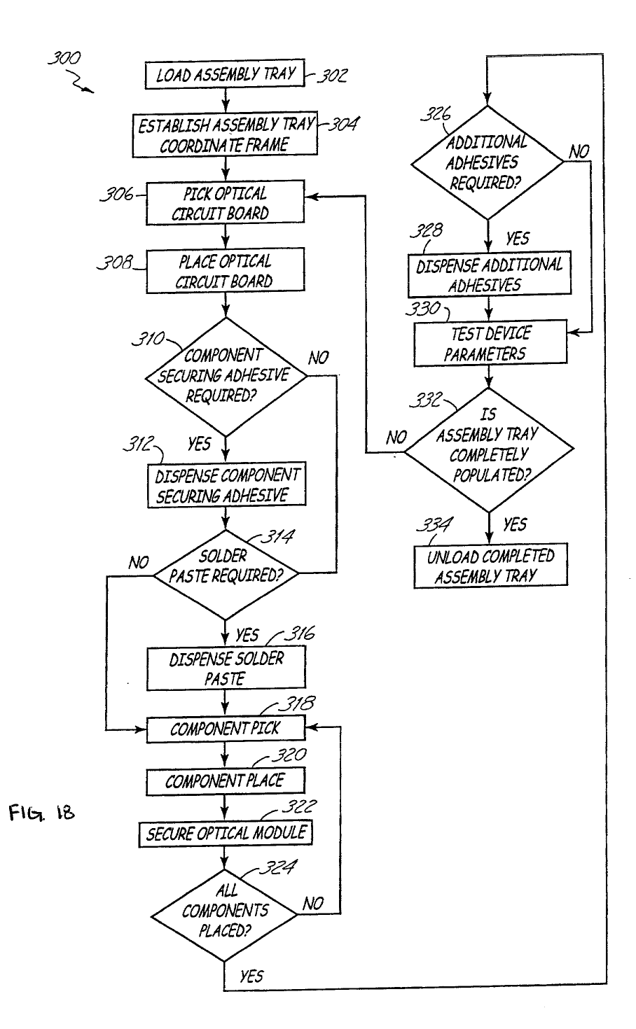

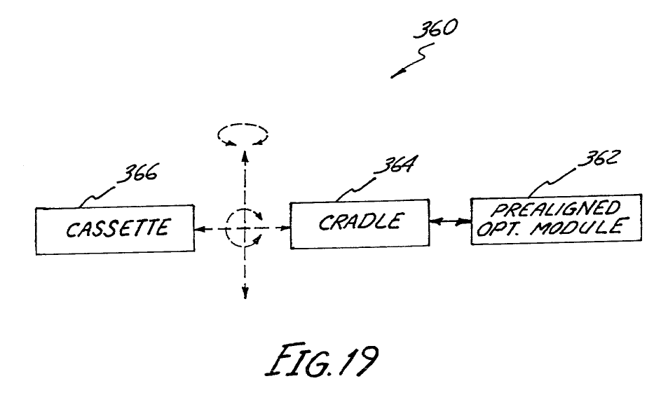

It should be appreciated the above sequence of pick up, imaging, placement, dispensing, soldering, curing, etc., is meant only to portray a representative example and sequence. Another example is illustrated in FIG. 18 discussed below. Other sequences and types of operations are possible and may be adjusted based on the design of the optical circuit. It may also be necessary for placement head 8 to change grippers 81, vacuum nozzles 83, or contact probes 87 using automatic tool changer 66 during the placement sequence in order to accommodate a variety of different components.

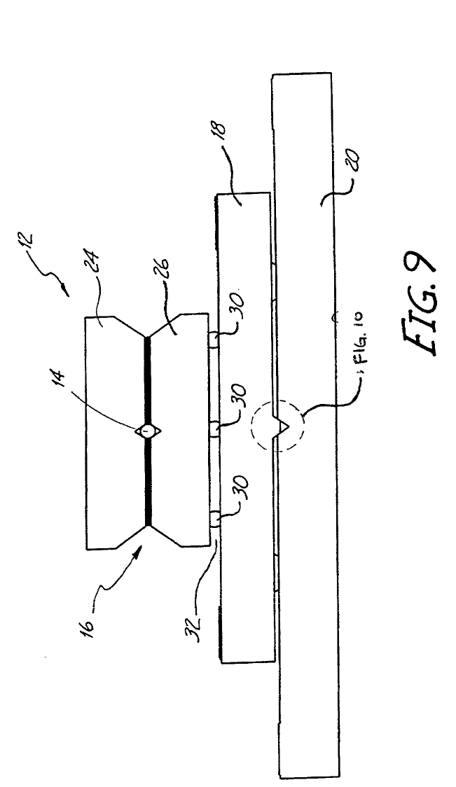

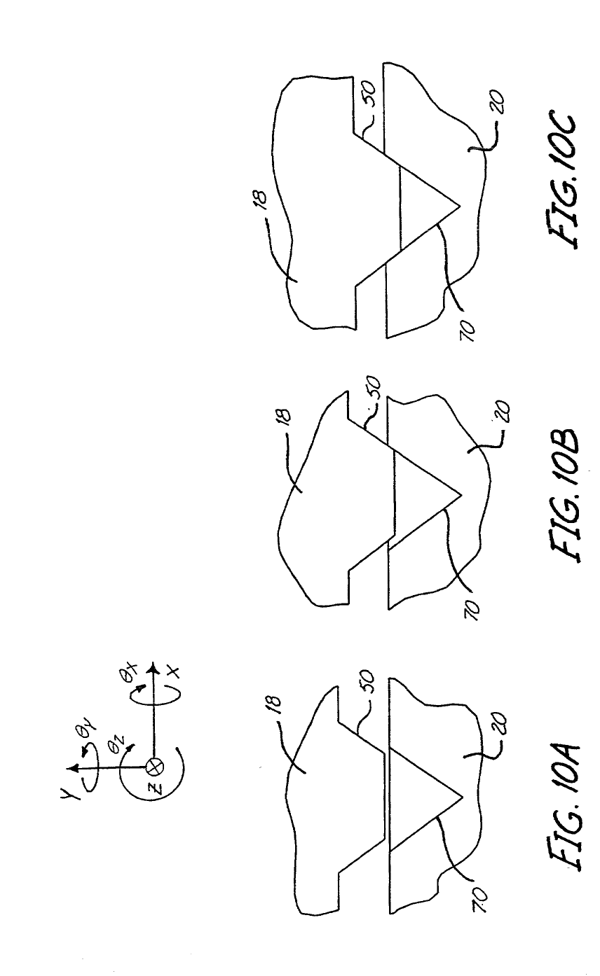

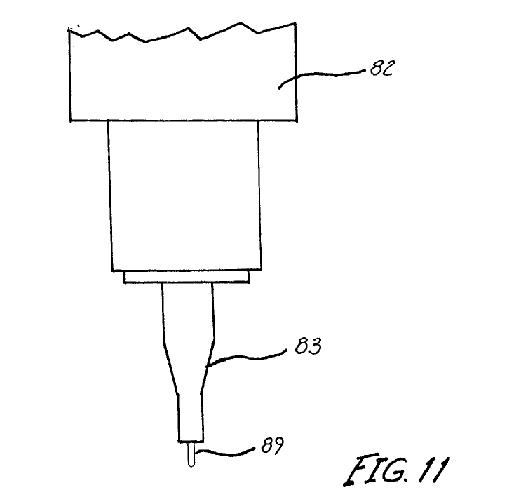

FIGS. 9 and 10 demonstrate how the mating registration features guide the placement of the optical modules onto the optical circuit board to obtain sub-micron mechanical and optical alignment. As discussed above, with this configuration, the positional accuracy requirements of pick and place machine 2 are substantially reduced than if pick and place machine 2 was required to directly align optical and opto-electronic components.

FIG. 9 is cross-sectional view 9-9 from FIG. 6 of optical circuit 10. The dashed area indicates the region of one set of mating features between fiber module 12 and optical circuit board 20. FIGS. 10A, 10B, and 10C, which are enlarged areas of the dashed area in FIG. 9 show how the mating process works during different time phases of the placement of optical module 12 onto optical circuit board 20.

In FIG. 10A, mesa 50 is shown held by placement head 8 just above V-groove 70. In FIG. 10B the optical module 12 has been lowered further until mesa 50 has just contacted V-groove 70. As placement head 8 lowers fiber module 12 further still, V-groove registration feature 70 guides mesa 50 until it is fully seated as shown in FIG. 10C. This self-registering process is a general property of all kinematic-style mounting methods. In this aspect, the component gripping mechanism of placement head 8 should be compliant in the X, Y, θₓ, θ_{y}, and θ_{z} direction while the actuator or articulator is lowering optical module 12. This compliance may be obtained by the optical module slipping laterally on vacuum nozzle 83 while articulator 82 drives the optical module in the Z direction. A class of robotic grippers known as “compliance wrist” end effectors may also be used to obtain compliance. Example compliance wrists are available from Robohand, Inc. of Monroe, Conn.

Another alternative vacuum gripper design is shown in FIG. 11 that has the compliance necessary to properly seat optical modules into optical circuit boards. Vacuum nozzle 83 is adapted to have retractable push rod 89. Push rod 89 is retracted up into vacuum nozzle 83 during the pick up of an optical module and during the initial placement of the optical module. When mesa feature 50 reaches the point of contact shown in FIG. 10B, motion of articulator 82 is stopped and vacuum to nozzle 83 is shut off. Push rod 89 is then lowered and pushes the optical module down. Due to the rounded tip of push rod 89, the optical module may slip laterally and/or at an angle in order to fully seat as shown in FIG. 10C. This gripper design also works with other types of kinematic-style mounting structures.

In one aspect, the compliance wrist or vacuum gripper provide a gripper in which the compliance can be controlled. For example, while inspecting or positioning an element that is held by the gripper, it is desirable for the element to be fixedly held. However, once the element has been placed, or partially placed, the gripper should provide compliance to allow the passive alignment of the element. A brake or other securing element can be used to fix a compliance wrist to provide controllable compliance. With a vacuum gripper, controllable compliance can be obtained by releasing or reducing the vacuum.

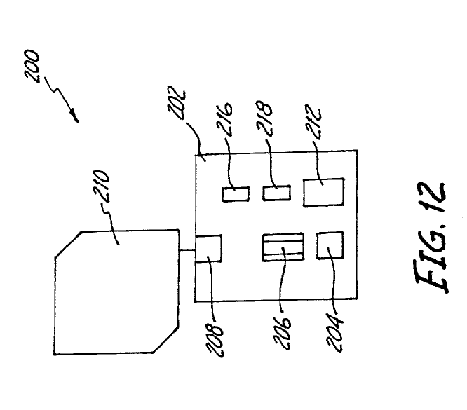

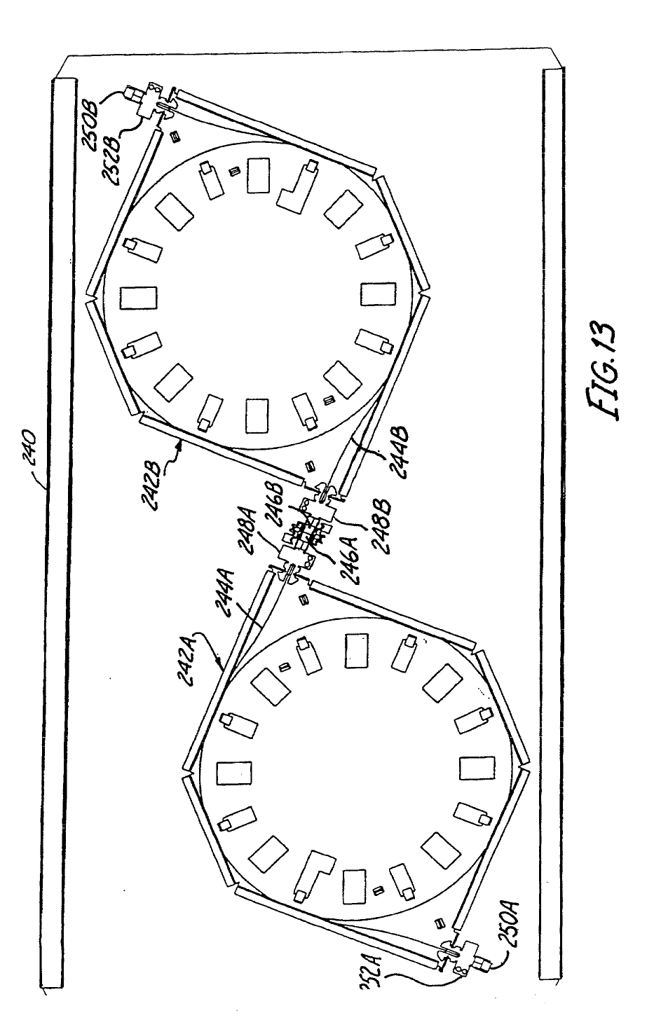

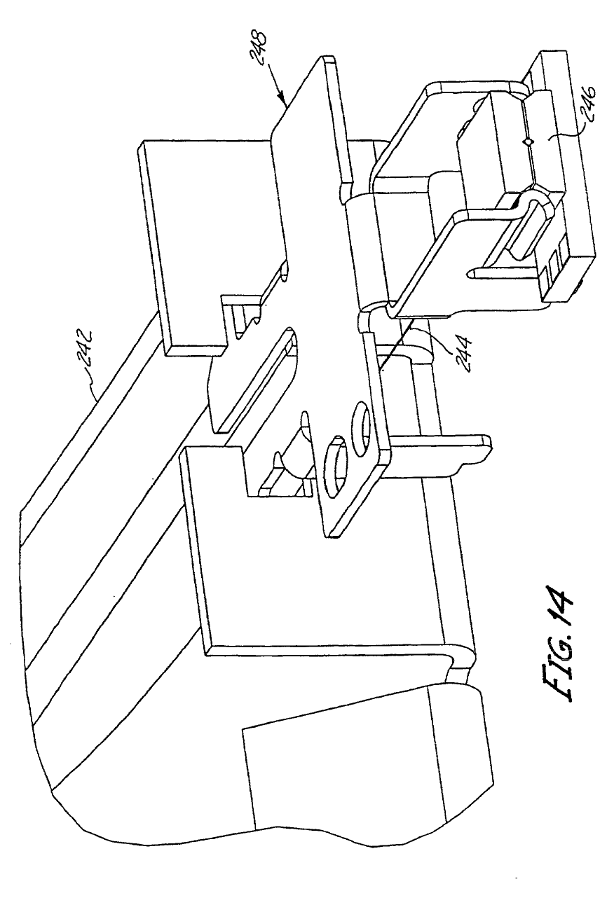

Another example optical circuit that pick and place machine 2 is adapted to assemble is shown in FIG. 12. FIG. 12 is a top plan view of laser transmitter 200. Constituent components include optical circuit board 202, laser module 204, lens module 206, fiber module 208, modulator IC 212, and discrete electrical components 216 and 218. Fiber cartridge or cassette 210, in which a spool of optical fiber is wound, is shown in FIG. 12 and is a convenient device for pick and place machine 2 to manipulate long lengths of optical fiber.

FIG. 13 is a top plan view showing one specific embodiment of the present invention for use in manipulating optical modules which are coupled to long fiber optic “pigtails.” FIG. 13 is a top plan view showing a carrier or assembly tray 240 that contains fiber cassettes 242A and 242B. Fiber cassettes 242A and 242B carry spools of fiber 244A and 244B. Each fiber 244A and 244B is coupled to a respective optical module 246A and 246B such as those discussed above. Of course, other optical module configurations can also be used. These modules are prealigned and, in combination with the cassette, are well suited for automated assembly processes.

The optical modules 246A and 246B are supported in respective cradles 248A and 248B. During automated assembly, the optical modules 246A,B can be gripped by gripping cradles 248A,B which are themselves loosely coupled to the fiber cassettes 242A,B, respectively. In FIG. 13, the two optical modules 246A and 246B are shown in an assembled positioned in which they form an optical device. The opposed ends of the optical fibers 244A and 244B can carry additional optical modules 250A and 250B in cradles 252A and 252B, respectively.

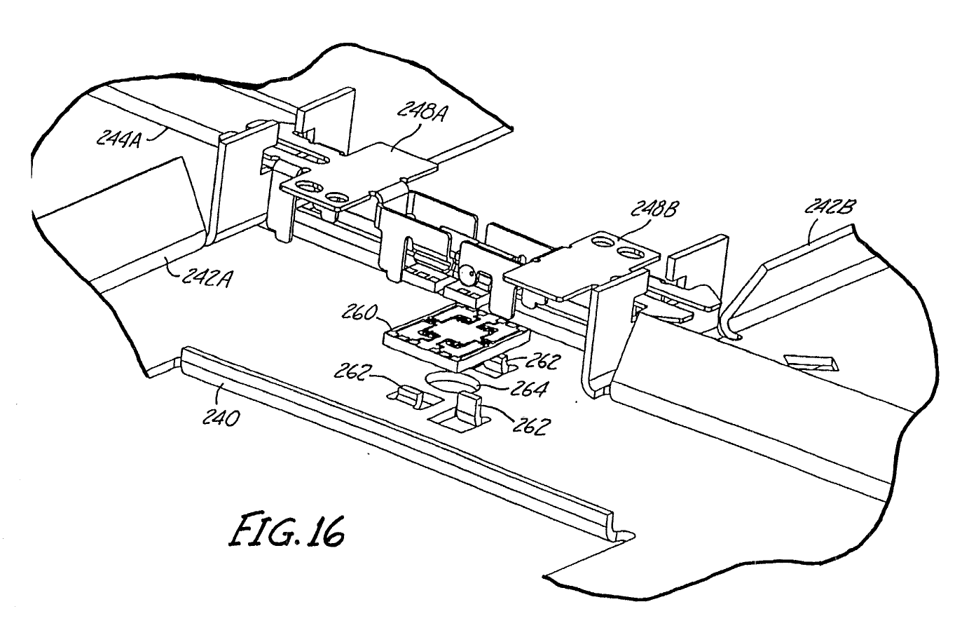

FIG. 14 is a cutaway perspective view showing cradle 248 in greater detail carrying prealigned optical module 246. The cradle 248 “floats” in the fiber cassette 242 to provide sufficient freedom of movement of module 246 when mounted onto the fixed reference. The cradle 248 is loosely coupled to cassette 242 such that the cradle is allowed limited relative movement. Further, this configuration allows the cassette 242 to be picked up without requiring separate support to cradle 248 and optical module 246.

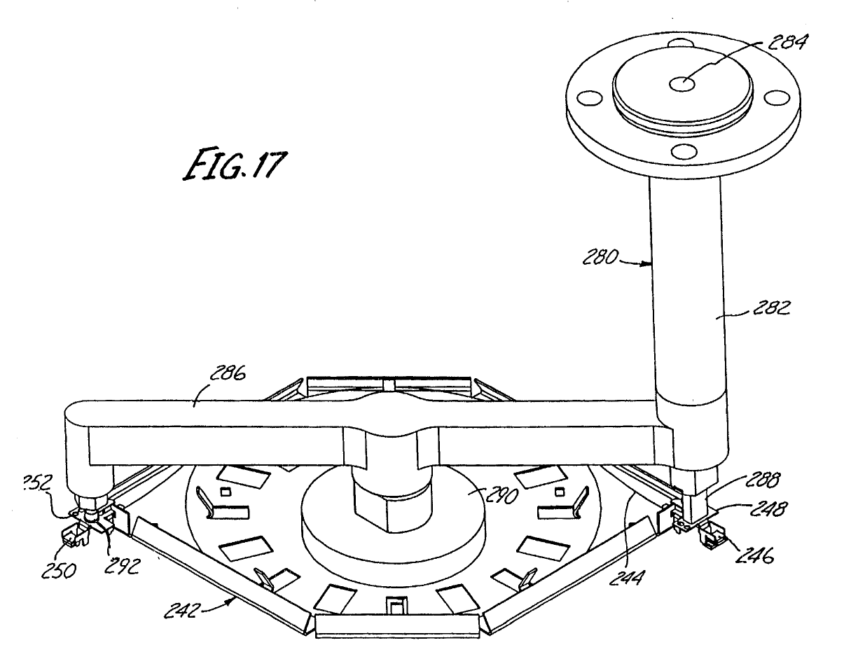

FIG. 15 is a top plan cutaway view and FIG. 16 is a side perspective floated cutaway view of optical modules 246A,B positioned over fixed reference 260 and held in cradles 248A, 248B, respectively. Fixed reference 260 is aligned by registration features 262 in carrier 240. An opening 264 can be used to apply a vacuum to the fixed reference 260 during the assembly process to thereby secure the fixed reference 260. The pick and place machine can include electrical contacts for coupling to contacts on fixed reference to thereby melt solder to bond the prealigned optical modules to the fixed reference 260.

FIG. 17 is a perspective view of cassette 242 secured in a specific example vacuum gripper assembly 280 which is one example of interchangeable gripper such as those illustrated in FIG. 8. Vacuum gripper assembly 280 includes a main axis 282 having a vacuum conduit 284 formed therethrough. A lateral projection 286 to the side of main axis 282 provides a vacuum connection to primary cradle nozzle 288, cassette vacuum cup 290 and the remote nozzle 292. Cradle nozzle 288 is configured to couple to cradle 248 through application of a vacuum through vacuum conduit 284. Nozzle 288 may itself provide some compliance. Cassette vacuum cup 290 is configured to support cassette 242 through a vacuum connection at a center of cassette 242. Finally, secondary cradle vacuum nozzle 292 is configured to grasp cradle 252. Accurate alignment and placement of module 250 is not typically required. Module 250 can be used to align or test module 246 by providing an optical input to one module and observing an output.

Assembly 280 is one example of a three point connection to a fiber/optical module assembly in accordance with one aspect of the invention. In some embodiments a single nozzle or two nozzles are employed. Assembly 280 allows the pick and place machine to position a module 246 and the associated optical fiber 244 during fabrication of an optical device. Assembly 280 can be one of the tools illustrated in FIG. 8 and selectively used by the pick and place machine.

FIGS. 13-16 illustrate one specific embodiment of the present invention and the invention is intended to include broader aspects and should not be limited to this specific embodiment. In one general aspect, the present invention includes a pick and place machine that holds a prealigned optical module. In another aspect, the invention includes a pick and place machine that holds an optical module, either prealigned or not prealigned, along with a fiber pigtail that couples to the module. The coupling to the module and fiber can be at one point, two locations, or more locations. This is illustrated in FIG. 17. In one embodiment, a cassette carries the fiber and the pick and place machine grasps the cassette. The pick and place machine can allow limited relative movement of the optical module, for example, through the configuration of the gripper or nozzle that grasps the module and/or the cradle which carries the module.

The kinematic registrations features of the optical module and the optical circuit board are designed to constrain the optical module in one or more of the 6 degrees of freedom, X, Y, Z, θ_{X}, θ_{Y} and θ_{Z}, once it is placed on the optical circuit board. The kinematic registration features allow sub-micron precision alignment between the optical module and the optical circuit board. However, the pick and place robot may not have the accuracy to directly place the optical module onto the optical circuit board and have the registration features align to sub-micron precision. Therefore, the gripper, or end effector, that places the pre-aligned optical modules should be compliant in order for the registration features of the optical module to mate properly with the registration features of the optical circuit board.

FIG. 18 is a block diagram showing one example sequence of steps in accordance with the present invention. Block diagram 300 is an example of a sequence of steps in accordance with the present invention. At block 302, an assembly tray is loaded and its reference frame is established at block 304. For example, this can be using a camera imaging system or other appropriate technique.

At block 306, an optical circuit board is grasped using an appropriate gripper. The gripper can be changed as necessary. The gripper is placed over the circuit board and its position and orientation can be identified using imaging techniques. An optional serial number can also be recorded. At block 308, the optical circuit board is placed onto the assembly tray and can be clamped using a suitable method such as a vacuum.

At block 310, control is passed to block 312 if a securing adhesive is required. If not, control is passed directly to block 314 which determines whether solder paste is required for the component. The solder can be for securing or to provide an electrical connection. If so, solder paste is dispensed at block 316. If no solder paste is required, control is passed directly to block 318 and a component that may include an optical module is grasped. The appropriate gripper is selected for grasping the component. The gripper is positioned over the component and the component's orientation is determined using appropriate imaging techniques. Again, an optional serial number from the component can be recorded.

At block 320, the component is placed at the proper location on the circuit board. Typically, prior to this step, the orientation of the component is identified using visual reference features carried on the component. An upward looking camera or other imaging technique can be used. The optical module is secured at block 322, for example using solder or other adhering or securing technique. The tools used by the pick and place machine can be changed as necessary, for example, to electrically contact and heat solder carried on the components or on an optical circuit board.

At block 324, a determination is made whether all components have been placed. If there are additional components, control is passed to block 318. If not, control is passed to block 326 where a determination is made if additional adhesive is required. At block 328, additional adhesive dispense is required. Additional adhesive can be used for matching the optical index between adjacent components, providing component encapsulation and securing a component. In some embodiments, a curing step can be used in which radiation or heat is applied to adhere the adhesive. The device is then tested, as desired, at block 330 to determine its operating characteristics. At block 332, if the assembly tray is not completely populated, control is passed to block 306. Completed trays can be moved off the machine, for example, by a conveyor at block 334.

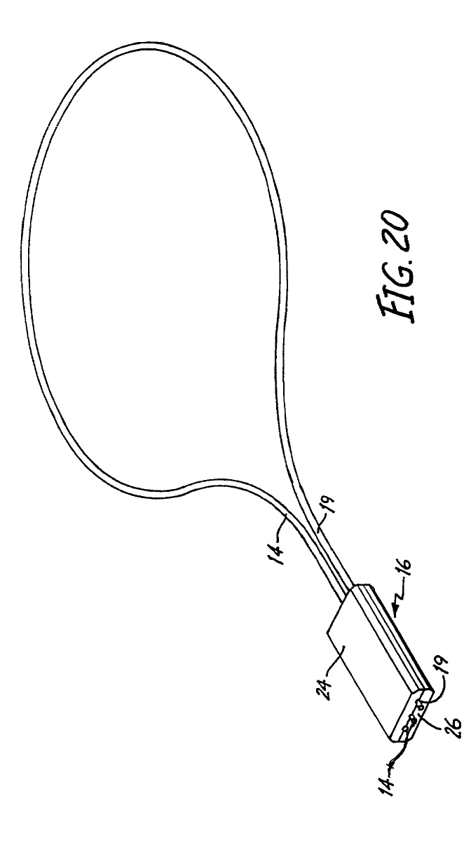

FIG. 19 is a simplified block diagram showing a cassette and cradle assembly 360. FIG. 19 is intended to illustrate broad aspects of the invention and shows a prealigned optical module 362 held in a cradle 364 of assembly 360. The cradle 364 is secured to cassette 366. However, the securing is preferably through a technique that allows limited relative movement, with at least one degree of freedom, between cradle 364 and cassette 366. This allows cradle 364 to be manipulated to align and place optical module 362 without disturbing or moving cassette 366.

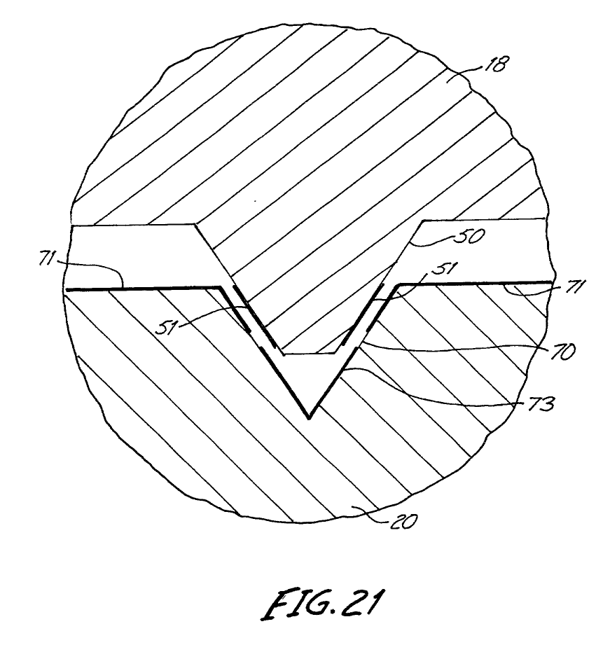

FIG. 20 shows another example fiber component mount 16 to facilitate manipulation of optical modules without a separate cassette mechanism. Fiber 14 and distal fiber end 19 are captured between top holder 24 and bottom holder 26. A distal end gripper 132 may be optionally used to support the fiber loop during manipulation of the optical module. Upon assembly of the optical circuit board, distal fiber end 19 may be cut or clipped from component mount 16. Fiber 14 may then be fusion spliced to another fiber, a connector may be added, or it may be connected to another optical device.

The embodiment of FIG. 21 allows the present invention to verify that optical module 12 and fixed reference 20 are mated properly. FIG. 21 is a cross-sectional view of mesa reference feature 50 being inserted into v-groove 70. Electrical traces 71 extend partially into v-grooves 70. Electrical traces 71 connect to contact pads not shown. Electrical trace 73 is deposited in the bottom of v-groove 70 and electrical trace 51 is deposited onto mesa registration feature 50. When registration feature 50 is seated properly into v-groove 70, a continuous electrical connection is established between electrical traces 71 through electrical traces 51 and 73. If registration feature 50 does not seat properly into v-groove 70, there will be an open circuit between electrical traces 71. Hence, the contact pads connected to electrical traces 71 may be monitored, for example by contact probe 87, for electrical continuity during the mounting of optical module 12 onto fixed reference 20 to verify proper mating. Other configurations of registration features, electrical contact pads, and traces are possible to verify proper mating of optical module 12 and fixed reference 20 and the example shown in FIG. 21 is only illustrative of one configuration.

In one aspect, the present invention uses a surface mount approach of placing an optical module onto an optical circuit board from above. In such an embodiment, the robot end effector should apply a small, stiff force in the downward or Z direction to mate the optical module with the optical circuit board. The end effector should be compliant in the other five degrees of freedom X, Y, θ_{X}, θ_{Y} and θ_{Z}, in order to allow the registration features to guide the optical module into alignment with the optical circuit board. The nozzle of FIG. 11 has compliance in all degrees of freedom except the Z direction. It is also desirable to have the downward Z force be small when the registration features are made of brittle or fragile materials such as silicon, glass, or ceramic.

There are a number of commercial available products that allow robot end effectors to have compliance. These are known as compliant wrists or lateral alignment devices. The compliant wrists allow compliance in the X, Y, and θ_{Z}, directions while the lateral alignment devices allow compliance in the X and Y directions.

In various aspects, a pick and place machine is provided which is adapted for high speed, automated assembly of opto-electronic circuits. Mating registration features on optical modules and optical circuit boards easily facilitate sub-micron mechanical and optical alignment. A wide variety of high performance optical circuits may be assembled by mounting optical modules and other components onto appropriately configured optical circuit boards. Using prealigned optical modules with registration features greatly relaxes the positional accuracy requirements of the optical circuit pick and place machine. Although a Cartesian pick and place machine is illustrated, any configuration can be used including a SCARA configuration, or other configurations or their combinations. Multiple placement heads can also be used.

Although the present invention has been described with reference to preferred embodiments, workers skilled in the art will recognize that changes may be made in form and detail without departing from the spirit and scope of the invention. Although the invention has been illustrated using specific examples of optical modules, optical devices and pick and place machine components, the invention should not be interpreted as being limited to these specific examples. Unless language in the claims is specifically to the contrary, elements in the claims should be interpreted broadly, for example, in accordance with the broad block diagrams set forth herein. The pick and place machine of the invention can be used to place optical, electro-optical or electrical components. During or following the mounting of an optical module or a number of optical modules onto the fixed reference, the operation and/or alignment of the module(s) can be inspected. The inspection can be using a camera or other viewing device or through an active inspection in which the optical module(s) is operated and its output observed. This can be used to aid in the alignment and for quality control. This can be through the use of a functional inspection module that may contain an optical sensor, electrical measurement devices, optical sources, electrical sources, or other circuitry or optics that are used to inspect and measure the functional operation of the optical module.

What is claimed is:

1. A method of assembling an optical device, comprising:
obtaining a plurality of prealigned optical modules, the modules having an optical components prealigned with respect to registration features on the modules;
obtaining a fixed reference having a plurality of registration features configured to mate with the registration features of prealigned optical modules;
initially aligning a registration feature of at least one of the prealigned optical modules with a registration feature of the fixed reference, the aligning performed with a first level of accuracy; and
urging the at least one prealigned optical module and the fixed reference together following the step of initially aligning and thereby passively aligning the registration features of the module and the fixed reference due to cooperation between the registration feature of the at least one prealigned optical module and the registration feature of the fixed reference to align the prealigned optical module with the registration feature of the fixed reference with a second level of accuracy, the second level of accuracy being greater than the first level of accuracy.

2. The method of claim 1 wherein initially aligning a registration feature of at least one of the optical modules including:
grasping the at least one prealigned optical module from a supply of the plurality of prealigned optical modules; and
transferring the at least one prealigned optical module from the supply to the fixed reference.

3. The method of claim 2 including identifying an orientation of the at least one prealigned optical module.

4. The method of claim 1 wherein initially aligning includes grasping at least one of the prealigned optical modules with a gripper, the gripper having limited compliance to allow relative movement of the module in at least one dimension.

5. The method of claim 1 including gripping the prealigned optical module.

6. The method of claim 5 wherein gripping includes applying a vacuum to a vacuum nozzle.

7. The method of claim 1 wherein the registration features comprise at least a portion of a kinematic registration feature.

8. The method of claim 1 including adhering the prealigned optical module to the fixed reference.

9. The method of claim 8 wherein adhering includes soldering.

10. The method of claim 1 including applying an adhesive to secure the optical modules to the fixed reference.

11. The method of claim 1 including applying an adhesive which provides an optical index match between optical components.

12. The method of claim 1 including identifying an orientation of the optical module.

13. The method of claim 12 wherein identifying an orientation includes optically imaging the prealigned optical module.

14. The method of claim 1 including obtaining a serial number for a prealigned optical module.

15. The method of claim 14 wherein obtaining a serial number is through an optical inspection of the prealigned optical module.

16. The method of claim 1 including grasping the prealigned optical module and grasping an optical fiber pigtail coupled to the prealigned optical module.

17. The method of claim 16 wherein grasping the optical fiber pigtail comprises grasping a cassette which carries the pigtail.

18. The method of claim 16 including grasping a distal end of the optical fiber pigtail.

19. The method of claim 4 including fixing the gripper to eliminate the limited compliance prior to the initially aligning.

20. The method of claim 1 including selecting a tool on a placement head from a plurality of tools.

21. The method of claim 1 including providing an electrical connection to at least one of the prealigned optical module and fixed reference.

22. The method of claim 1 including providing a prealigned optical module through a component feeder mechanism.

23. The method of claim 1 including providing a laminar air flow.

24. The method of claim 1 including inspecting an alignment of a prealigned optical module following the step of releasing.

25. The method of claim 1 wherein urging comprises performing a kinematic registration.

26. The method of claim 25 wherein the registration features comprise a protrusion and a recess and performing a kinematic registration comprises seating the protrusions in the recesses.

27. The method of claim 25 wherein the urging is performed with sufficient compliance to allow the kinematic registration.

28. The method of claim 1 wherein urging comprises urging the optical module through a compliance wrist.

29. A pick and place machine configured to operate in accordance with the method of claim 1.

30. An optical device made in accordance with the method of claim 1.

31. The method of claim 9 including preheating a pad prior to soldering.

32. The method of claim 9 including heating the solder with a resistive heater, or laser.

33. The method of claim 9 wherein the soldering is performed in an atmosphere other than air to prevent or remove oxidation during bonding.

34. The method of claim 1 including gripping the at least one optical module at a fiber loop.

35. The method of claim 7 including verifying kinematic seating.

36. An apparatus for assembling optical devices, comprising:
an optical module gripper configured to selectively grasp a prealigned optical module;
a fiber optic pigtail gripper configured to selectively grasp a fiber optic pigtail coupled to prealigned optical module;
an actuator configured to move the optical module gripper between a source of prealigned optical modules and a fixed reference; and
a controller configured to control the actuator and the optical module gripper to cause the actuator to position the optical module gripper proximate the source of prealigned optical modules where the optical module gripper grasps a prealigned optical module, moves the prealigned optical module proximate the fixed reference and places the prealigned optical module in registration features of the fixed reference.

37. The apparatus of claim 36 wherein the actuator is coupled to the fiber optical pigtail gripper.

38. The apparatus of claim 36 wherein the optical module gripper comprises a vacuum nozzle.

39. The apparatus of claim 36 wherein the fiber optic pigtail gripper comprises a vacuum nozzle.

40. The apparatus of claim 36 including a distal end gripper configured to couple to a distal end of the fiber optic pigtail.

41. The apparatus of claim 40 wherein the distal end gripper comprises a vacuum nozzle.

42. The apparatus of claim 40 wherein the distal end gripper is coupled to the actuator.

43. The apparatus of claim 36 wherein the fiber optic pigtail is carried in a cassette.

44. The apparatus of claim 36 including a camera coupled to the controller to identify an orientation of the prealigned optical module.

45. The apparatus of claim 36 wherein the optical module gripper comprises a compliance wrist.

46. The apparatus of claim 36 including electrical probes configured to couple to electrical contacts on the prealigned optical module to provide an electrical connection to heating elements configured to heat solder.

47. The apparatus of claim 36 including electrical probes configured to couple to the fixed reference to provide an electrical connection to heating elements configured to heat solder.

48. The apparatus of claim 36 including a source of laminar air flow.

49. The apparatus of claim 44 wherein the camera is mounted on the actuator.

50. The apparatus of claim 46 wherein electrical contacts are carried on the actuator.

51. The apparatus of claim 36 including a bar code reader configured to read a bar code carried on the prealigned optical module.

52. The apparatus of claim 51 wherein the bar code reader is mounted on the actuator.

53. The apparatus of claim 36 including a plurality of interchangeable tools selectively coupleable to the actuator.

54. The apparatus of claim 36 wherein the optical module gripper comprises a vacuum nozzle having a vacuum nozzle and a push rod, the push rod configured to provide a downward force against the optical module.

55. The apparatus of claim 54 wherein the push rod allows limited lateral and/or angular movement of the optical module.

56. The apparatus of claim 43 wherein the pigtail is spooled.

57. The apparatus of claim 36 wherein the optical module is carried in a cradle and the optical module gripper is configured to grip the cradle.

58. The apparatus of claim 57 including a cassette configured to carry the fiber pigtail and wherein the cradle is loosely coupled to the cassette.

59. The apparatus of claim 36 wherein the optical module couples to the fixed reference through a kinematic mount.

60. An apparatus configured to carry a prealigned optical module, comprising:
a cassette configured to support an optical fiber pigtail coupled to the prealigned optical module; and
a cradle configured to hold the prealigned optical module, the cradle loosely coupled to the cassette to allow limited relative movement between the cradle and the cassette.

61. The apparatus of claim 60 wherein the cradle is configured to be grasped by a pick and place machine.

62. The apparatus of claim 60 wherein the cassette is configured to be grasped by a pick and place machine.

63. The apparatus of claim 60 including a distal cradle configured to hold an optical module coupled to a distal end of the fiber optic pigtail, the distal cradle loosely coupled to the cassette.

64. The apparatus of claim 60 wherein the prealigned optical module includes an indentation and wherein the cradle includes a protrusion configured to fit into the indentation to thereby secure the prealigned optical module in the cradle.

65. The apparatus of claim 60 wherein the cassette is configured to hold a spool of optical fiber.

66. An apparatus for assembling an optical device, comprising:
a source of prealigned optical modules;
an optical module gripper configured to compliantly grip a prealigned optical module;
an actuator configured to move the optical module gripper between the source of prealigned optical modules and a fixed reference; and
a controller configured to control the actuator and the gripper whereby the gripper grasps a prealigned optical module from the source of optical modules, aligns registration features on the optical module with registration features on the fixed reference and urges the registration features together.

67. The apparatus of claim 66 wherein the controller identifies an orientation of the at least one prealigned optical module.

68. The apparatus of claim 66 wherein the gripper has limited compliance to allow limited relative movement of the module relative to the gripper in at least one dimension.

69. The apparatus of claim 66 wherein gripper applies a vacuum to a vacuum nozzle.

70. The apparatus of claim 66 wherein the registration features comprise a kinematic registration.

71. The apparatus of claim 66 including a source of adhesive to adhere the prealigned optical module to the fixed reference.

72. The apparatus of claim 66 wherein the controller heats solder to secure components and/or provide an electrical connection.

73. The apparatus of claim 66 wherein the gripper has a controllable compliance.

74. The apparatus of claim 66 including a camera to optically image the prealigned optical module.

75. The apparatus of claim 66 wherein the controller identifies a serial number of the prealigned optical module.

76. The apparatus of claim 66 including a second gripper to grasp an optical fiber pigtail coupled to the prealigned optical module.

77. The apparatus of claim 76 wherein second gripper grasps a cassette which carries the pigtail.

78. The apparatus of claim 76 including a third gripper to grasp a distal end of the optical fiber pigtail.

79. The apparatus of claim 66 including a plurality of selectable tools coupled to the actuator.

80. The apparatus of claim 66 wherein the source includes a component feeder mechanism.

81. The apparatus of claim 66 including a source of laminar air flow.

82. The apparatus of claim 66 wherein the controller releases the prealigned optical module from the gripper and subsequently inspects an alignment of a prealigned optical module.

83. The apparatus of claim 66 wherein the registration features comprise a protrusion and a recess.

84. The apparatus of claim 66 wherein gripper comprises a compliance wrist.

85. The apparatus of claim 66 wherein the controller is further configured to place an electrical component on the fixed reference.

86. The apparatus of claim 66 including electrical probes configured to electrically contact the prealigned optical module.

87. The apparatus of claim 66 including electrical probes configured to electrically contact the fixed reference.

88. The apparatus of claim 66 including electrical probes configured to melt solder to secure the prealigned optical module.

89. The apparatus of claim 66 including electrical probes configured to melt solder to provide an electrical connection to the prealigned optical module.

90. The apparatus of claim 66 including an adhesive dispenser configured to dispense an adhesive.

91. The apparatus of claim 90 wherein the adhesive secures the prealigned optical module to the fixed reference.

92. The apparatus of claim 90 wherein the adhesive encapsulates the prealigned optical module.

93. The apparatus of claim 69 including a push rod to urge the prealigned optical module from the vacuum nozzle.

94. The apparatus of claim 66 wherein the optical module gripper has a controllable compliance.

95. The apparatus of claim 66 including a functional inspection module configured to test operation of the optical module.

96. The apparatus of claim 95 wherein the functional inspection module is configured to test the optical module after the optical module is placed in the fixed reference.

97. The apparatus of claim 36 or 66 including a laser to heat solder.

98. The apparatus of claim 36 or 66 including a source of a nitrogen atmosphere or a forming gas for use during soldering.

99. The apparatus of claim 36 or 66 wherein the controller verifies a kinematic seating.
